(19) United States
(12) Patent Application Publication
(10) Pub. No.: US 2010/0017388 A1
(43) Pub. Date: Jan. 21, 2010

(54) SYSTEMS AND METHODS FOR PERFORMING A MULTI-STEP CONSTRAINED SEARCH

(76) Inventor: Eric Glover, Santa Clara County, CA (US)

Correspondence Address: JONES DAY, 222 EAST 41ST ST, NEW YORK, NY, 10017, US

(21) Appl. No.: 12/177,088

(22) Filed: Jul. 21, 2008

(51) Int. Cl. G06F 17/30

(52) U.S. Cl. 707/5; 707/E17.001

(57) ABSTRACT

Systems, methods, and computer-readable media for performing a user search query are provided. A search definition profile having one or more domain constraints and one or more vertical constraints, specified by a site owner, is obtained. A first search for documents is executed with the search query for a first search result. The first search result is constrained to documents in a search engine index that satisfy a collective domain constraint imposed by the one or more domain constraints. Without user intervention, a second search for documents is executed with the search query for a second search result when a relevance condition of the first search result, specified by the site owner, is not satisfied. The second search result is constrained to a collective vertical constraint imposed by the one or more vertical constraints. An output search result that is combination of the first and second search results is provided.

### FIELD OF THE INVENTION

This invention relates to improved systems and methods for performing constrained Internet searches.

### BACKGROUND OF THE INVENTION

An important type of web search is the “site search.” A “site search” is used by a web site to allow users of their site to find desired content, but use a commercial (general-purpose) search engine such as Google to execute the search. The ultimate goal of a site search feature is to satisfy users of a particular focused site, e.g. a digital camera site wants users to find articles about digital camera reviews. Currently, general purpose web search engines, such as Google, have limited ability to perform preferential searches beyond simply constraining the searches to a given domain or URL.

Providers of websites that provide site search capability desire to regulate the type of content a searching user sees in response to a site search. For example, a provider of a website that has a site search capability does not want users of the site search capability to be returned content that disparages the provider's products. The traditional solution, such as that provided by Google's site-search products, is to allow web site provides to restrict site-searches to content in a specified domain. For instance, a provider of a website can restrict all results returned from such site searches to pages on their domain under the frequently asked questions (FAQ) directory.

The net result of conventional site searches is that site search users may not get an adequate response to their queries. The search response may contain no documents, or no documents that are helpful. For example, a user searching the Motorola website for a FAQ on how to use a brand new model phone might find no search result on the Motorola website, even though user groups, which are favorable towards Motorola, might have relevant content.

Given the above background, what is needed in the art are improved systems and methods for providing site searches.

### SUMMARY OF THE INVENTION

The present invention addresses the need arising in the art for improved systems and methods for searching for documents using the Internet or other wide area networks by providing multi-step preferential searches. A first search responsive to a user's query is similar to existing solutions such as Google Custom Search, where the user's query is domain constrained (e.g., constrained to a specified site, a specific directory, a specific Uniform Resource Location path, etc.). However, advantageously, when the first search does not provide a sufficient search result, one or more supplemental vertically constrained searches are performed to augment the original search without user intervention. In other words, the one or more supplemental vertically constrained searches are performed automatically, typically without the search requestor's knowledge. These one or more vertically constrained supplemental searches do not need to contain a domain constraint, such as the one from the original search, but rather are constrained on which categories of documents may by included in the supplemental search result. In other words, the one or more supplemental searches are vertically constrained.

To illustrate the advantages of the preferential searches, consider the case in which a MOTOROLA® customer using the MOTOROLA® web site to find out information on a specific MOTOROLA® product enters a product specific query. A first search responsive to this query may be domain constrained to the MOTOROLA® FAQ document database that contains MOTOROLA®'s prepared responses to such questions. In the prior art, such a search may come up empty handed because the search was so restricted. Advantageously, in the methods disclosed herein, one or more supplemental vertically constrained searches are performed in such instances to augment the first search. For example, the supplemental search can search all documents in a large document repository that relate to MOTOROLA® cell phones but are not pornography and do not disparage MOTOROLA®. Typically, the large document repository is a repository of documents that have been found on the Internet. Thus, if a searching user sends a search request to MOTOROLA®, using the systems and methods disclosed herein, and the first query fails to find a sufficient result, a second search using preferences of “FAQ,” “MOTOROLA® cell-phones,” “User-groups,” “English,” “non-spam,” “non-pornography,” “not from site Motorola-unauthorized.com” is likely to provide relevant documents that were missed by the first search. As this example indicates, the constraints on the one or more supplemental searches can be specified as a combination of “categories” or “genres” in both a positive (inclusive) and negative (exclusive) manner. The first search result and the supplemental search result are combined and outputted to the requester, typically without the searching user's knowledge that multiple searches have been performed.

### BRIEF DESCRIPTION OF THE DRAWINGS

FIG. 1 illustrates a computer system in accordance with some embodiments.

FIG. 2 illustrates a method for performing a search in accordance with some embodiments.

FIG. 3 illustrates collective vertical constraints in accordance with some embodiments.

Like reference numerals refer to corresponding parts throughout the several views of the drawings.

### DETAILED DESCRIPTION

The present invention provides methods, computers, computer systems, and computer readable media for performing a search query created by a user. Advantageously, this search query can be performed in a multi-step constrained fashion, if necessary. In typical embodiments, a user at a remote location communicates a search query, over the Internet or some other form of network connection, to a site owner. In typical embodiments, the site owner maintains a web page, a collection of web pages, or some other domain (hereinafter, “the site owner's domain”), that the searcher wishes to search.

Typically the user wishes to search the site owner's domain in order to obtain the answer to a question that the user believes should be addressed by the site owner's domain. Such a search request is termed a site-search. Rather than directly supporting the site-search, the site owner makes use of a search engine hosted by still another remote computer or computer system. Advantageously, the site owner can direct the search engine to perform a multistage search that provides optimal results to satisfy the user's query. The constraints that dictate how and whether a multi-step constrained search is to be performed by the search engine, in order to fulfill the site-search, are specified by a search definition profile. The search definition profile is associated in some way with the search query specified by the user. However, the user, nor the search engine, is able to control, specify, or alter the search constraints in the search definition profile. The search constraints in the search definition profile are controlled by, specified by, and modifiable by the site owner.

To fulfill a site-search request from a user, the site owner passes the user's search query to the search engine, which is typically hosted by one or more computers that are remote with respect to the site owner's domain. Thus, typically, the site owner passes the search query from a computer under control of the site owner, which received the user's search request, to a computer or computer system that hosts the search engine using the Internet or other electronic communication means. In alternative embodiments, the search request is passed directly from the user's computer to the search engine without passing through a computer operated by the site owner.

The search engine processes the user's search query. In some embodiments, the search definition profile may already be resident in the search engine computer system before the search query is received. In some embodiments, the search definition profile may be attached to the search query itself by the site owner. However, in such instances, the user still does not have access to or control over the constraints specified by the search definition profile. In some embodiments, the search engine computer system identifies the appropriate search definition profile to use from a plurality of stored search definition profiles based on the identity of the site owner that passes the search query to the search engine. In some embodiments, part of the search definition profile used to control the multi-step constrained search is stored on the search engine computer system that processes the search query and another part of the search definition profile is communicated to the search engine computer system from the site owner along with the search query.

In some embodiments, the search definition profile comprises at least two search definitions. In some embodiments, a first search definition in the search definition profile comprises a set of one or more domain constraints. In some embodiments, the one or more domain constraints specify a single domain, all or a portion of the domains owned or operated by a the site owner (e.g., a specific corporate entity), or some other portion of the domains available on the Internet. In typical embodiments, the first search definition in the search definition profile comprises the site owner's domain (e.g., a web site, a collection of web sites, or some other domain operated or controlled by the site owner). A second search definition in the search definition profile comprises one or more vertical constraints. These vertical constraints are category constraints which impose the requirement that documents returned by a search belong to one or more specific categories specified by the one or more vertical constraints. Thus, the second search definition differs from the first search definition in the sense that the second search definition requires (i) that documents returned from a search constrained by the second search definition be classified into one or more categories and (ii) that the categories that each document in the documents returned from a search constrained by the second search definition satisfy the collective category requirements specified by the second search definition. The second search definition further differs from the first search definition in the sense that the second search definition is not constrained by the domain constraints specified in the first search definition. The second search definition may be domain constrained, but typically the domain constraints in the second search definition are looser than the domain constraints in the first search definition thus allowing for evaluation of documents in a broader domain than the first search definition. The document characterization relied upon by the second search definition is performed during a document categorization event (e.g., automated or manual classification that is optionally off-line and is optionally part of a large scale process) prior to executing the search.

A first search result for a first query constrained by the first search definition is obtained by the search engine. When the relevance of the first search result does not achieve a predetermined relevance condition, a second search is performed with the query. The second search is constrained by the second search definition of the search definition profile. When the second search is performed, the output of the search is a combination of the first search result and the second search result.

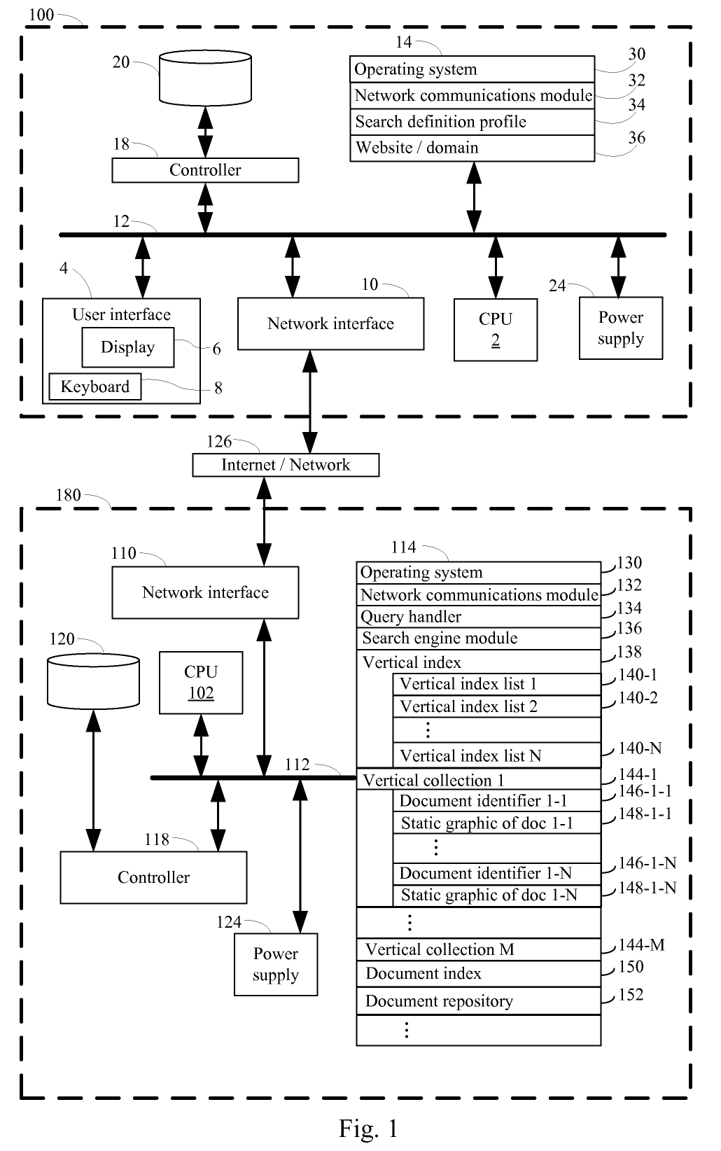

FIG. 1 illustrates a host search engine 180 in accordance with one embodiment of the present disclosure. In some embodiments, host search engine 180 is a computer system comprising one or more computers. It will be appreciated by those of skill in the art that host search engine 180 may use complicated computer architectures not shown in FIG. 1. Host search engine 180 will typically have one or more processing units (CPU's) 102, a network or other communications interface 110, a memory 114, one or more non-volatile storage devices 120 accessed by one or more controllers 118, one or more communication busses 112 for interconnecting the aforementioned components, and a power supply 124 for powering the aforementioned components. Data in memory 114 can be seamlessly shared with non-volatile storage devices 120 using known computing techniques such as caching. Memory 114 and/or memory 120 can include mass storage that is remotely located with respect to the central processing unit(s) 102. In other words, some data stored in memory 114 and/or memory 120 may in fact be hosted on computers that are external to host search engine 180 but that can be electronically accessed by the host search engine 180 over an Internet, intranet, or other form of network or electronic cable (illustrated as element 126 in FIG. 1) using network interface 110.

Memory 114 preferably stores:
an operating system 130 that includes procedures for handling various basic system services and for performing hardware dependent tasks;
a network communications module 132 that is used for connecting host search engine 180 to various computers such as computer 100 (FIG. 1) and possibly to other servers or computers via one or more communication networks, such as the Internet, other wide area networks, local area networks (e.g., a local wireless network can connect the computer 100 to search engine 180), metropolitan area networks, and so on;
a query handler 134 for receiving a search query from a computer 100;
a search engine module 136 for searching document index 150 and/or one or more optional vertical collections 144;
an optional vertical index 138 comprising a plurality of vertical indexes 140, where each vertical index is an index of a corresponding vertical collection 144;
an optional plurality of vertical collections 144, each optional vertical collection 144 comprising a plurality of document identifiers 146 and, for each respective document identifier 146, an optional static graphic representation 148 of the source URL for the document represented by the respective document identifier 146;
a document index 150 comprising a set of terms, a document identifier uniquely identifying each document associated with terms in the set of terms, and the scores of these documents; and
a document repository 152 comprising (i) a source URL or a reference to a source URL for each document in the document repository and, optionally, (ii) a static graphic representation of the source URL for each document in the document repository.

In the embodiment depicted in FIG. 1, documents are indexed in document index 150 and are also stored or indexed in vertical collections 144. A “vertical collection” comprises a set of documents (e.g., URLs, websites, etc.) that relate to a common category. For example, web pages pertaining to sailboats could constitute a “sailboat” vertical collection. In typical embodiments, documents are assigned vertical collection labels based on the content of such documents using pattern classification techniques (e.g., the application of trained classifiers that are trained to classify documents into vertical collections). Web pages pertaining to car racing could constitute a “car racing” vertical collection. In some embodiments, document index 150 specifies, for each respective document in the document index, which vertical collections the respective document belongs. In such embodiments, it is not necessary to have both a document index 150 and separate vertical collections 140 that are illustrated in FIG. 1. In such embodiments, a vertical collection 144 is a logical construct. In other words, the documents in a respective vertical collection are identified with a vertical label that identifies the respective vertical collection, rather than physically storing the documents of the respective vertical collection in a data structure or collection of data structures created for the purpose of storing documents of the respective vertical collection. Regardless of whether physical vertical collections 144 are created (e.g., one or more data structures created for the purpose of storing the documents of a particular vertical collection) or logical vertical collections 144 are used, each respective indexed document can be in any number of different vertical collections 144 that are relevant to the respective indexed document. Moreover, there is no requirement that the documents in a given vertical collection 144 be physically located on the same machine or data store.

As illustrated in FIG. 1, host search engine 180 is connected via Internet/network 126 to a computer 100. FIG. 1 illustrates the connection to only one such computer 100. However, in practice, host search engine 180 can be connected to 10 or more computers 100, 100 or more computers 100 or more, 10,000 or more computers 100 or any number of computers 100. Further, in practice, each computer 100 can be connected to one or more computers (not shown) that are used by searches (e.g., 100 or more such computers or more, 10,000 or more such computers or more, or any number of such computers). Furthermore, in some embodiments host search engine 180 is a cluster. FIG. 1 is provided to give an exemplary system in accordance with an embodiment of the invention. However, it will be appreciated that any system or collection of systems that supports (A) a plurality of search users that communicate site searches to a website controlled by a site owner, (B) that allows the site owner to define the criterion or criteria for any of the multi-stage site searches described herein, and (C) that supports the communication of such site searches to a general purpose centralized search engine where the site searches from the search users are carried out in the multi-stage manner specified by the site owner. Such systems or collections of systems have three classes of parties: (A) search users, (B) at least one site owner, and (C) a search engine. These three parties interact with each other in the manner disclosed herein.

In the architecture illustrated in FIG. 1, computer 100 is a computer that is controlled by the site owner. This site controls a website, collection of websites or some other domain 36 (hereinafter “domain 36”) that offers a site-specific search. Users submit search queries to domain 36. In one example, the site owner is a company and the domain 36 is the company website. In such embodiments, users submit site specific search queries to the website from remote locations using the Internet/Network 126. The architecture shown in FIG. 1 may be altered without deviating from the scope of the present invention. For example, as is the case with many small companies, the domain 36 may be on a host computer (not shown) that hosts the websites for many third parties. However, regardless of the specific architecture, the site owner has control over the domain 36 and the domain 36 provides some means for performing a site-specific search. In typical embodiments, computer 100 comprises
one or more processing units (CPUs) 2;
a network or other communications interface 10;
a memory 14;
optionally, one or more magnetic disk storage devices (or other form of non-volatile memory) 20 accessed by one or more controllers 18;
an optional user interface 4, the user interface 4 including a display 6 and a keyboard 8;
one or more communication busses 12 for interconnecting the aforementioned components; and
a power supply 24 for powering the aforementioned components.

In some embodiments, data in the memory 14 can be seamlessly shared with the optional non-volatile memory 20 using known computing techniques such as caching. In some embodiments, the client device 100 does not have a non-volatile memory 20, or at least does not have magnetic non-volatile memory. In some embodiments, the client device 100 is a portable handheld computing device and the network interface 10 communicates with the Internet/network 126 by wireless means. Memory 14 preferably stores:
an operating system 30 that includes procedures for handling various basic system services and for performing hardware dependent tasks;
a network communication module 32 that is used for connecting computer 100 to search engine 180;
a search definition profile 34; and
a website 36 that hosts a site-specific query.

In some embodiments, the search definition profile 34 is stored on host search engine 180 rather than computer 100 In such embodiments, when a search query from domain 36 is sent to query handler 134 for processing, query handler 134 must obtain the search definition profile 34. In some embodiments, query handler 134 obtains the search profile by using an index or code provided by the search query to lookup the search profile 34 in a data store (e.g. local disk) that is stored by host search engine 180 or that is electronically accessible to host search engine 180 over Internet/network 126. In the architecture illustrated in FIG. 1, the search definition profile 34 is stored on host 100 and is sent along with a search query by domain 36 to host search engine 180 as part of the search query. A user submitting a site-specific search query to domain 36 has no control over the search definition profile regardless of whether the search definition profile is stored on the computer 100, search engine 180, or a computer or computer readable media that is electronically accessible to search engine 180. In preferred embodiments, the search definition profile is stored on search engine 180, not computer 100, and only an identifier to the site owner's search engine profile is sent with a user's query to host search engine 180 from computer 100.

As illustrated in FIG. 1, host search engine 180 comprises a number of data structures such as optional vertical index 138, optional vertical collections 144 and/or document index 150. These data structures can be in any form of data storage including, but not limited to, a flat file, a relational database (SQL), or an on-line analytical processing (OLAP) database (MDX and/or variants thereof). In some embodiments, these data structures are stored in a database that comprises a star schema that is not stored as a cube but has dimension tables that define hierarchy. Still further, in some embodiments, these data structures are stored in a database that has hierarchy that is not explicitly broken out in the underlying database or database schema (e.g., dimension tables that are not hierarchically arranged). In some embodiments, these data structure are stored on search engine 180. In other embodiments, some or all of these data structures are hosted on (stored on) one or more computers that are addressable by host search engine 180 across Internet/network 126 or in computer readable media that is electronically accessible by search engine 180. In some embodiments, all or a portion of one or more of the program modules depicted in host search engine 180 of FIG. 1 are in fact resident on a computer other than host search engine 180 that is addressable by host search engine 180 across Internet/network 126.

In the context of this application, documents (e.g., documents in document repository 152) are understood to be any type of media that can be indexed and retrieved by a search engine, including web documents, images, multimedia files, text documents, PDFs or other image formatted files, ringtones, full track media, and so forth. A document may have one or more pages, partitions, segments or other components, as appropriate to its content and type. Equivalently a document may be referred to as a “page,” as is commonly used to refer to documents on the Internet. No limitation as to the scope of the invention is implied by the use of the generic term “documents.”

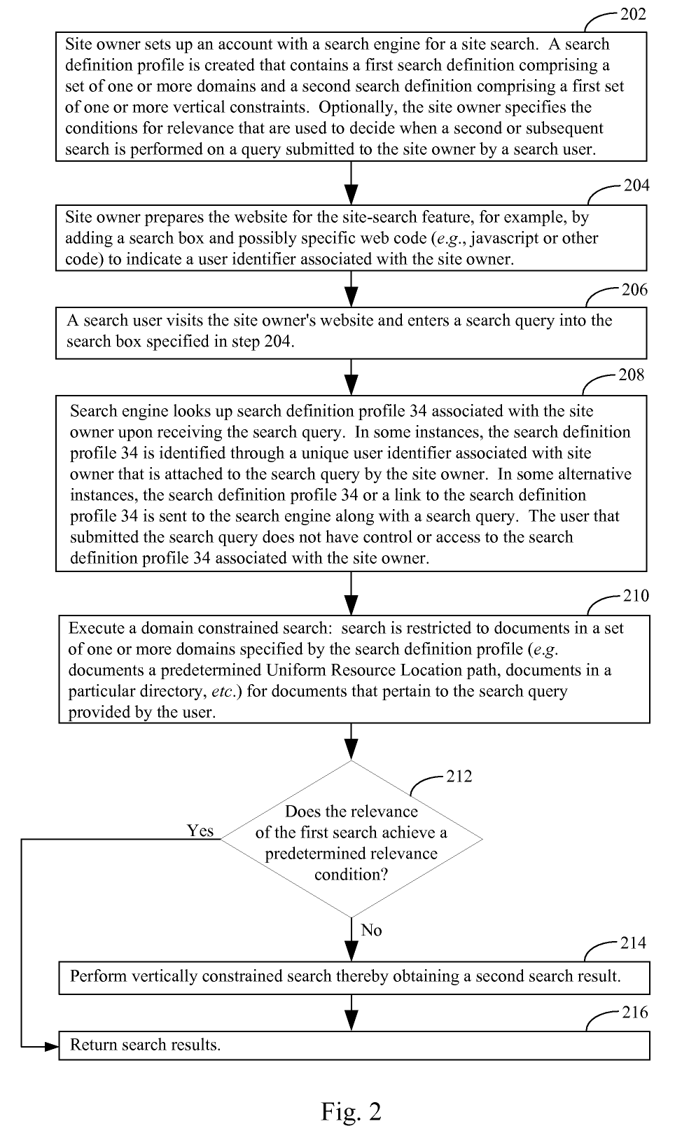

Now that exemplary computer systems in accordance with one aspect have been described, exemplary methods will be detailed. Referring to FIG. 2, in step 202, a site owner sets up an account with a search engine for a site-search. For instance, the site owner may own or control website, collection of websites, or domain 36 referenced in FIG. 1 (hereinafter “domain 36”). In some embodiments, the site owner sets up an account by specifying profile preferences in a search definition profile 34. In some embodiments, for example, the search definition profile 34 comprises a first search definition comprising a set of one or more domain constraints and a second search definition comprising a first set of one or more vertical constraints. This search definition profile 34 can be stored on a computer 100 that hosts website 36. Alternatively, and more preferably, this search definition profile 34 is submitted to another computer, such as host search engine 180 where it is stored. In some embodiments, a vertical constraint specifies that a document must be in any of a predetermined set vertical collections and/or not be in any of a predetermined set of vertical collections.

The site owner specifies conditions for relevance that are used to determine when additional tests are performed. For example, in some embodiments the first search definition specifies the constraints for a first search, the second search definition specifies the constraints for the second search, and the relevance determines when the second search is to be performed based on a relevance of the first search.

In step 204, the site owner prepares the domain 36 for the site-search feature disclosed herein. In some embodiments, step 204 involves adding a search box and possibly some special web code (e.g., javascript or other code) to a website controlled by the site owner to indicate a user identifier associated with the site owner.

In step 206, a user visits the site owner's domain 36 and enters a query into the search box specified in step 204.

In step 208, the query provided by the user is sent to query handler 134 and/or search engine module 136 on search engine 180. In some embodiments, query handler 134 is a component of search engine module 136. In some embodiments, query handler 134 and search engine module 136 are the same software module. In some embodiments, a user identifier provided by domain 36 is sent to host search engine 180 along with the search. The user identifier identifies the site owner. In such embodiments, the user identifier is used to identify the search definition profile 34 associated with the site owner. In some alternative embodiments, the search profile 34 or a link to the search profile 34 is sent to host search engine 180 along with a search submitted by the user. The search profile 34 or the link to the search profile is then used to implement the multi-step search requirements of the site owner in the manner described herein. In any of these embodiments, a host search engine 180 can support the search definition profiles 34 of multiple site-owners, where each site-owner specifies the constraints of their own multi-step search query.

In step 210, a domain constrained search is executed in which the search is limited to the searching of documents that satisfy the set of one or more domain constraints specified in the search definition profile 34 of the site owner and that have been indexed by host search engine 180 and that are therefore represented by document index 150 of host search engine 180 when the search request is processed by search engine 180. This means that documents that satisfy the one or more domain constraints specified in the search definition profile 34 of the site owner but that have not been indexed by host search engine 180 when the search request is processed, and therefore are not accounted for by document index 150 (document 150 contains no reference to), will not be evaluated during step 210 or during any steps of the method disclosed in FIG. 2. In some embodiments, this domain constrained search is run against all of the documents of document index 150, which is not domain constrained, and then documents that do not satisfy the collective domain constraint of the one or more domain constraints specified by the search definition profile 34 (the domain constrained documents) are filtered out. Regardless of which approach is taken, each of the documents in the search result in step 210 is constrained to the set of one or more documents that satisfy the collective domain constraint of the one or more domains specified by the search definition profile 34 that have been indexed by host the search engine 180 when the search request is processed. Examples of domains that could be specified by domain constraints in the search definition profile 34 include specified sites, specific directories, specific Uniform Resource Location paths, etc. Regardless of the embodiment, the one or more domain constraints specified by the search definition profile 34 is domain-constrained, meaning that documents that satisfy the one or more domain constraints specified by the search definition profile limited to documents that from a specific set of domains, or portions thereof, that have been indexed by search engine 180, as opposed to documents from any domain on the Internet that have been indexed by search engine 180. In some embodiments, the search query provided by a user is a product search query for a product that is manufactured and/or sold by the site owner.

The present invention is not limited to running a single domain constrained search in step 210. One or more searches can be run in step 210, where each of the one or more searches is domain constrained. For instance, a first search could be run on the documents in a first directory that have been indexed by host search engine 180 and a second search could be run on the documents in a second directory that have been indexed by search engine 180, and so forth, and then the search result from each of the searches can be combined in any manner known in the art.

It will be understood that, in some embodiments, the documents to which the search 210 search result are limited to can be stored by search engine 180, can be stored in a predetermined URL path, and, in fact, can be stored on one or more computers and/or one or more data storage devices that are accessible to host search engine 180 across Internet/network 126 provided that such documents have been indexed by search engine 180. In some embodiments, the documents are stored on a single computer (e.g., search engine 180). In some embodiments, the documents are accessible at a predetermined uniform resource location path (e.g., www.motorola.com). In some embodiments, search 210 is limited to those documents in a predetermined second-level domain name or a predetermined plurality of second-level domain names that have been indexed by host search engine 180 at the time the search request from the user is processed by search engine 180. A second-level domain name is a domain name that is directly below a top-level domain. For example, in wikipedia.org, “wikipedia” is the second-level domain of the top-level domain “org.” In some embodiments, search 210 is limited to all URLs in a predetermined plurality of second-level domain names that comprises a predetermined search string that have been indexed by host search engine 180 at the time the search request from the user is processed by search engine 180. For instance, search 210 can be limited to all URLs in second-level domains that contain the string “motorola.” In some embodiments, a search 210 is limited to all URLs that contain a regular expression (e.g. a regex). Regular expressions are described in “Regular Expressions,” The Single UNIX® Specification, Version 2, The Open Group, 1997; Forta, Sams Teach Yourself Regular Expressions in 10 Minutes, Sams. ISBN 0-672-32566-7, Friedl, Mastering Regular Expressions, O'Reilly, ISBN 0-596-00289-0, Habibi, Real World Regular Expressions with Java 1.4, Springer, ISBN 1-59059-107-0; Liger et al., Visual Basic .NET Text Manipulation Handbook, Wrox Press, ISBN 1-86100-730-2; Sipser, “Chapter 1: Regular Languages,” Introduction to the Theory of Computation, PWS Publishing, 31-90, ISBN 0-534-94728-X; and Stubblebine, Regular Expression Pocket Reference, O'Reilly, ISBN 0-596-00415-X, each of which is hereby incorporated by reference. In some embodiments, a search 210 is limited to all URLs in predetermined second-level domains that contain a regular expression (e.g. a regex). In some embodiments, search 210 searches web pages indexed by host search engine 180 that are from a predetermined URL path.

In some embodiments, the domain constraints of the first search constrain the first search to a plurality of documents from one or more domains, specified by the site owner, that have been indexed by host search engine 180 and the site owner (e.g., a single person, a single company, the web site owner) has created each of the documents in the plurality of documents. In some embodiments the domain constraints of the first search constrain the first search to a plurality of documents from one or more domains, specified by the site owner, that have been indexed by host search engine 180 and the site owner has edit privileges for each of the documents in the plurality of documents. In some embodiments the domain constraints for the first search constrain the first search to a plurality of documents from one or more domains, specified by the site owner, that have been indexed by host search engine 180 and the site owner has control over the original source document for each respective document in the plurality of documents.

An example of the search of step 210 (the first search) is a user submitting to the Motorola web site a search for a frequently asked question (FAQ) on how to use a brand new model phone. The user enters the model number of the phone as a search query into domain 36. The computer 100 transmits this search query across Internet/network 126 to the search engine 180. Referring to FIG. 1, the query handler 134 parses the search expression and the search engine module 136 searches documents that the host search engine 180 has indexed from the domains, or portions thereof, specified by the site owner for documents that pertain to the search expression. In this example, the site owner has control over the original documents because such original documents are accessed through the domain controlled by MOTOROLA®. Host search engine 180 searches through a search index that was built, in part, by indexing copies of such original documents. In some embodiments in accordance with this example the first domain is a predetermined uniform resource location (URL) path. An example of a predetermined URL path is “www.motorola.com.” A restricted search of this type is advantageous to the host (e.g., MOTOROLA®) because the host has control over what documents might be found by the search. In this way, the host can control the type of content the user retrieves and therefore ensure that the user obtains accurate and helpful information that does not disparage the user. It will be appreciated that there is some inherent latency in the site owner's control in this example. For instance, if the site owner (e.g., MOTOROLA®) changes a document in the first domain (e.g., by adding key words to the document that will make it more relevant to a particular search query), this change will not be reflected in the document index of the host search engine 180 until the host search engine 180 updates the index by reindexing the documents in the first domain. In other words, since it is the document index of the search engine, or vertical collections derived from the vertical index that are searched in the first search, and not the original documents themselves, modifications to the original documents will not affect the first search until such modified documents have been indexed by the search engine.

A restricted search of the type described in this example, while beneficial to the site owner because the site owner has control over the source documents, may not be so advantageous to the user because there may not be any useful content in the documents in the domains specified in the first search, even though user groups, not directly authorized or sanctioned by Motorola, might have a suitable answer to the FAQ. This drawback is overcome by doing a second search (search 214) if the first search (210) does not find a sufficient search result. In some embodiments, the site owner specifies domains for the first search that the site owner does not control. For example, in some embodiments the site owner may specify one or more domains that are highly relevant to a site-search, such as a government web site, a trade organization web site, a well respected blog service, or some other well respected source of information. In such instances, the first search is limited to those documents in such sources specified by the site-owner that have been indexed by the host search engine 180 when the site-search is processed.

It will be appreciated that, in some embodiments, search 210 is not limited to domain constrained documents 152 but in fact can be any documents found on the Internet provided that they are represented by document index 150 at the time when search 210 is processed. In such embodiments, the search result is filtered and only those documents that are from the one or more domains controlled by the site owner (e.g., are from computer 100, are from a predetermined URL path, etc., are from the set of domain constrained documents 154) are considered to be the search result of search 210. In this embodiment, documents that do not qualify as being from the set of one or more domains, or portions thereof, specified by the search definition profile are not considered to be in the search result even though they may be highly relevant to the search query. Such embodiments have the drawback of determining the relevance of documents that ultimately will not qualify as a search result even if they are relevant to the search query. In some embodiments, search 210 identifies two or more documents, five or more documents, ten or more documents, between 2 and 1000 documents, or less than 100 documents that are deemed to be relevant to the search query based on some measure of relevance known in the art. In some embodiments, the set of one or more domains, or portions thereof, specified by the search definition profile is 100 or fewer domains, 50 or fewer domains, 10 or fewer domains, five or fewer domains, a single domain, a collection of websites, or a single website.

In some embodiments, the first search is constrained to documents that satisfy the collective document constraint of the one or more domain constraints in the search definition profile. In some embodiments, a domain constraint is a positive constraint that requires that a document identified in the first search result be from a particular domain. In some embodiments, a domain constraint is a negative constraint that requires that a document identified in the second search result not be from a particular domain. To illustrate, consider a set of domain constraints that imposes (i) a positive domain constraint that requires that documents be from domain A and (ii) a negative domain constraint that requires that documents not be assigned from domain B. The collective domain constraint for this exemplary set of domain constraints are all documents indexed by host search engine 180 that from domain A but not from domain B. Note that domain A and domain B may overlap. For example, domain A may be a second level domain and domain B may any URL in domain A that has a predetermined regular expression. In such an instance, the collective domain constraint is any document that has been indexed that from domain A that is not at a URL that contains the predetermined regular expression. In another example, consider a set of domain constraints that imposes (i) a positive domain constraint that requires that documents be from domain A or (ii) a negative domain constraint that requires that documents not be from domain B. The collective domain constraint for this exemplary set of domain constraints are all documents indexed by host search engine 180 that are from domain A or are not from domain B. The domain constraint imposed by the one or more domain constraints can be any logical combination of positive and negative domain constraints. In step 212 the relevance condition of the search result of step 210 is determined. The relevance condition of the search result of step 210 can be determined in any number of ways known in the art. The relevance condition can be, for example, the number of search hits returned by a search function, some measure of quality of the hits returned by a search function, or some mathematical (linear or nonlinear) combination of (i) the number of search hits returned by a search function and (ii) the quality of the search hits returned by a search function. The search function can be any search function known in the art.

In some embodiments, the relevance condition determined in step 212 is the number of documents in the first search result that each have, in turn, a relevance score that is greater than a predetermined relevance. The predetermined relevance can be any relevance value that is deemed to indicate that a document in the search result is relevant to a search query. In some embodiments, the relevance condition of the first search result is a summation of the relevance of each of the documents in the first search result. Relevance of a particular document to a search query can be scored any number of ways in order to determine the relevance value of the document with respect to a search query. Such scoring methods determine relevance based on some judgment of relatedness of a document to a given search query based on one or more criteria. Examples of criteria that can be used to score a document include, but are not limited to, textual relevance as well as a function that considers textual relevance in conjunction with a link graph. One example of determining a relevance condition for a document is a relevance function that requires that one or more of the search terms, provided by the user, be in the title of the document. Another example of determining a relevance condition for a document is a relevance function that requires that one or more of the search terms, provided by the user, appear a predetermined number of times within the first 250 kilobytes of the document.

In step 212 a determination is made as to whether the relevance of the first search (the search of step 210) achieves a predetermined relevance condition. In some embodiments, a search result with a higher relevance value, which is one form of relevance condition, is more relevant to a given search query than a search result with a lower relevance value. In such embodiments, the relevance of the first search achieves the predetermined relevance condition when the relevance of the first search result is equal to or greater than a predetermined relevance value. Equivalently, relevance can be scored in step 212 in such a manner that a search result with a lower relevance value is more relevant to a given search query than a search result with a higher relevance value. In such embodiments, the relevance of the first search achieves the predetermined relevance condition when the relevance of the first search result is less than a predetermined relevance value.

The specific condition for the predetermined relevance condition used in step 212 is application dependent. That is, it will depend on the manner in which a relevance condition is computed in step 210. Furthermore, it will depend on what type of search result will be tolerated by host search engine 180 as being considered acceptable. In some embodiments the predetermined relevance condition is specified by the site owner. For example, in some embodiments, the predetermined relevance condition is stored in the search definition profile 34 and is communicated to the relevant software module in either computer 100 or host search engine 180 that performs the relevance determination of step 212.

In some embodiments, the relevance condition of the first search result is a number of documents that are deemed to be relevant from the first search and the predetermined relevance condition used in step 212 is a minimum number of documents (e.g., the number of documents in the first search that receive a score of 60 using some predetermined relevance scoring technique). For example, consider the case in which the predetermined relevance condition requires five documents and the first search result returned only four documents. This results in condition 212—No and the execution of the second search 214. On the other hand, consider the case in which the predetermined relevance condition requires five documents and the first search result returns six documents. This results in condition 212—Yes and process control passes on to step 214 where the first search result is outputted and the second search is not performed. As used herein, the term process control means an operation performed by one or more software modules in a computer or computer system without human intervention.

When a determination is made that the relevance of the first search result does not achieve a predetermined relevance condition (e.g., is less than a predetermined relevance value specified by the condition, is greater than a predetermined relevance value specified by the condition, etc.) (212—No), a second search for documents is made without human intervention (e.g., without intervention from the user or the site owner). This second search is represented in FIG. 2 as step 214. The second search uses the same search query that was used in the first search. Furthermore, in typical embodiments, the user that submitted the search query has no idea that the second search is performed. However, the scope of the second search (e.g., the documents that are searched and/or the documents that are identified as a search result in the second search) is vertically constrained in that it is limited by a first set of vertical constraints that contains one or more vertical constraints. That is, the second search is constrained to documents that satisfy the collective vertical constraint logically imposed by the one or more vertical constraints in the first set of vertical constraints. In some embodiments, a vertical constraint is a positive constraint that requires that a document identified in the second search result be assigned a particular vertical label. In some embodiments, a vertical constraint is a negative constraint that requires that a document identified in the second search result not be assigned a vertical label.

To illustrate, consider a first set of vertical constraints that imposes (i) a positive vertical constraint that requires that documents be assigned vertical label A and (ii) a negative vertical constraint that requires that documents not be assigned vertical label B. The collective vertical constraint for this exemplary first set of vertical constraints are all documents indexed by host search engine 180 that have label A but not label B. Note that a single document may be labeled with several different vertical labels (e.g., may be in several different vertical collections).

In another example, consider a first set of vertical constraints that imposes (i) a positive vertical constraint that requires that documents be assigned vertical label A or (ii) a negative vertical constraint that requires that documents not be assigned vertical label B. The collective vertical constraint for this exemplary first set of vertical constraints are all documents indexed by host search engine 180 that have label A or do not have label B.

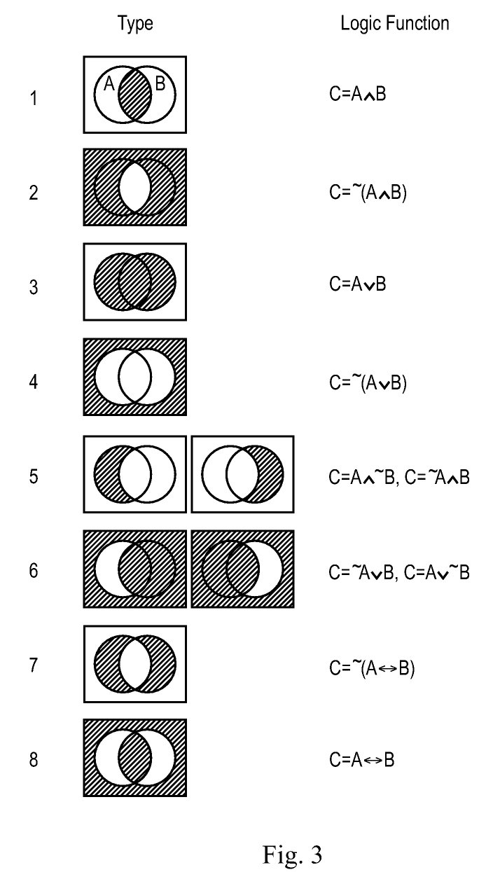

The collective vertical constraint imposed by the first set of one or more vertical constraints can be any logical combination of positive and negative vertical constraints. FIG. 3 provide 8 nonlimiting examples of collective vertical constraints. In exemplary collective vertical constraint 1 of FIG. 3, document C satisfies the collective vertical constraint imposed by the first set of one or more vertical constraints if and only if document C is in vertical collection A and vertical collection B. In exemplary collective vertical constraint 2 of FIG. 3, document C satisfies the collective vertical constraint imposed by the first set of one or more vertical constraints if and only if document C is not in vertical collection A or document C is not in vertical collection B. In exemplary collective vertical constraint 3 of FIG. 3, document C satisfies the collective vertical constraint imposed by the first set of one or more vertical constraints if and only if document C is in vertical collection A or document C is in vertical collection B or document C is in both vertical collection A and vertical collection B. In exemplary collective vertical constraint 4 of FIG. 3, document C satisfies the collective vertical constraint imposed by the first set of one or more vertical constraints if and only if document C is not in vertical collection A and is not in vertical collection B. In exemplary collective vertical constraint 5 of FIG. 3, document C satisfies the collective vertical constraint imposed by the first set of one or more vertical constraints if and only if document C (i) is in vertical collection A but is not in vertical collection B or (ii) is not in vertical collection A but is in vertical collection B. In exemplary collective vertical constraint 6 of FIG. 3, document C satisfies the collective vertical constraint imposed by the first set of one or more vertical constraints if and only if document C (i) is in vertical collection B or is not in vertical collection A or (ii) is not in vertical collection B or is in vertical collection A. In exemplary collective vertical constrain 7 of FIG. 3, document C satisfies the collective vertical constraint imposed by the first set of one or more vertical constraints if and only if document C (i) is in vertical collection A or is vertical collection B but is not in both vertical collection A and vertical collection B. In exemplary collective vertical constraint 8 of FIG. 3, document C satisfies the collective vertical constraint imposed by the first set of one or more vertical constraints if and only if document C is (i) in both vertical collection A and vertical collection B or (ii) is absent from both vertical collection A and vertical collection B.

In some embodiments, a vertical constraint requires that a document identified in the second search result not be assigned any vertical label in a predetermined set of one or more vertical labels.

In order to determine whether documents in the second search result satisfy the collective vertical constraint imposed by the set of one or more vertical constraints specified by the site owner, documents that are searched by the vertically constrained search are assigned vertical labels prior to implementing the vertically constrained search. Typically, there is a document categorization event that is performed prior to executing the vertically constrained search in which each document in document repository 152 (FIG. 1) is categorized and hence assigned one or more vertical labels. In fact, because this document categorization event typically takes much longer than the first search or the second search, this document categorization event, in which each document in a document repository 152 is assigned one or more vertical labels (categories), takes place some time before step 206 in which a user submits a query. Then, during the vertically constrained search, documents that are relevant to the search query and that have vertical labels that satisfy a vertical constraint in the first set of one or more vertical constraints are included in the search results for the vertically constrained search. In some embodiments, documents that are one vertical collection should not belong to another vertical collection. For example, documents in a vertical collection that are in the vertical collection with the label “child safe” should not contain documents related to pornography (e.g., should not contain documents that are in a pornography vertical collection). In some embodiments, each vertical constraint in the first set of one or more vertical constraints is a category in a plurality of categories present in the Internet or some other form of wide area network. An example of a category present in the Internet is sports. Thus, there are pages on the Internet that can be assigned the vertical label “sports” because they contain one or more words that are typically found in web pages pertaining to the subject of sports. In some embodiments, vertical labels are assigned to documents in document repository 152 using an automated classifier that is trained to identify documents of a particular category. For example, a support vector machine or other form of classifier such as a neural network can be trained, using a document training set, to recognize documents that pertain to sports. This classifier can then be used to determine which documents on the Internet or other form of wide area network should be assigned the vertical label “sports.” Of course, combinations of classifiers, each trained to assign a particular vertical label to documents that are deemed to belong to a certain category, can be used to assign documents with vertical labels. Moreover, a given document can be assigned more than one vertical label. In some embodiments, vertical labels are assigned to documents in the document index of host search engine 180 by a human, or through some tagging mechanism (e.g. delico.us, FLIKR, etc.).

The individual vertical constraints in the first set of one or more vertical constraints that are imposed in the second search (step 214) can be either inclusive of one or more vertical labels (e.g., all sports), exclusive of one or more vertical labels (e.g., not pornography), or some combination of being inclusive of some vertical labels and being exclusive of other vertical labels (e.g., inclusive of the “FAQ,” “Motorola cell-phones,” “User-groups,” and “English,” vertical labels and exclusive of the “Nokia,” “spam,” and “pornography” vertical labels. In some embodiments, an inclusive vertical constraint requires that each document in the second search result be associated with at least one predetermined category in a limited set of predetermined categories. For example, the inclusive vertical constraint may require that each document in the second search result provide a predetermined service, a predetermined class of services, a product, or a predetermined class of products. In some embodiments, an exclusive vertical constraint requires that each document in the second search result not be in a set of predetermined categories. For example, an exclusive vertical constraint may require that each document in the second search not provide a predetermined service, a predetermined class of services, a predetermined product, or a predetermined class of products.

In some embodiments, the set of one or more vertical constraints that is used to constrain the second search consists of a plurality of vertical constraints and the documents identified in the second search are restricted to those documents that have been assigned both a first vertical label and a second vertical label specified by the plurality of vertical constraints. For example, the vertically constrained search could be constrained to documents that have been assigned both the vertical labels “sports” and “history.” In another example, the vertically constrained search could be constrained to documents that are constrained to “personal digital assistants” and “wireless.” Of course, the vertically constrained search can be constrained to documents that have been assigned more vertical labels than just a first vertical label and a second vertical label. For instance, the second search can be constrained to documents that each have been assigned the same predetermined first, second and third vertical label, the same predetermined first, second, third and fourth vertical label, and so forth. Correspondingly, in some embodiments, the vertically constrained search is restricted to those documents that have been assigned a first vertical label (or any of a plurality of first vertical labels) but not a second vertical label (or any of a plurality of second vertical labels). In some embodiments, the vertically constrained search is restricted to those documents that have a predetermined relevance to a predetermined category. Of course, more complex logical requirements can be imposed by the first set of one or more vertical constraints in order to form a collective vertical constraint and examples of such more complex logical requirements that can be used to form collective vertical constraints are described above in conjunction with FIG. 3.

As noted above, vertical labels are assigned to the documents used in search 214 (the vertically constrained search) prior to executing the search. For instance, in one approach, each of the vertical labels to which the second search is constrained corresponds to a vertical collection of documents. The assignment of documents to vertical collections 144 is a document categorization event. Each such vertical collection has a characteristic vertical label (e.g., “sports,” “sports and not pornography,” etc.). In other words, there is a one-to-one correspondence between vertical labels and vertical collections. In some embodiments vertical collections are not physically created. For instance, in some embodiments, the document index of the search engine tracks which vertical collections a given document belongs to rather than creating the physical vertical collections 144 or the vertical index 138 depicted in FIG. 1. The physical vertical collections 144 and vertical index 138 depicted in FIG. 1 are provided to illustrate the concept of vertical collections 144. However, in some embodiments, vertical collections 144 and vertical index 138 are present in host search engine 180 in the manner depicted in FIG. 1.

Through web-crawling of the Internet, or some other set of documents distributed across a network of computers, a document repository 152 is built using known techniques. For example, if the web-crawling occurs over the Internet, each respective document in the document repository 152 will comprise a source URL or a reference to a source URL for the respective document. In some embodiments, classifiers assigns documents to one or more vertical collections 144 by direct analysis of documents in the document repository 152 for specific search terms contained within the documents of the document repository. In some embodiments, additional information is stored as meta-data for each document and classifiers use this additional information to assist in classifying documents in the document repository 152 in vertical collections.

In some embodiments, the information that is stored as meta-data for each respective document in document repository 152 is a set of search terms contained within the respective document, information about the respective document from a web graph (e.g., what documents on the Internet link to the respective document, what types of documents on the Internet link to the respective document), human judgment (e.g., the manual classification of the respective document by a human) or a classification of the location of the document on the Internet (e.g., documents at www.playboy.com are equated to the classification erotica). Typically, search terms such as the presence of specific words or phrases in the documents are stored in the metadata of the respective document. However, the present invention is not limited to the afore-mentioned search terms, features from a web graph, and other features. Any conceivable feature could be used by a classifier for classifying a document such as the prominence of specific words in the documents (e.g., words in title, bolded words, etc.), the position of words in the documents, etc. Furthermore, there is no requirement that such classification information be stored in the metadata associated with the document.

Advantageously, in some embodiments of the present invention, the vertical labels that are assigned to each respective document in the document repository are stored in the document repository 152. Then, when a document index 150 is built from a document repository 152, the document index 150 can be built using conventional search terms, the vertical labels, and other features. Thus, from the document repository 152, a document index 150 is constructed by scanning documents in the document repository and the meta-data for such documents for the conventional search terms, the vertical labels, and other features. An illustration of document index 150 is illustrated below:

| Search term, vertical | |
|---|---|
| label or other feature | Document Identifier |
| 1 (e.g., cat) | docID₁ₐ, . . . , docID₁ₓ |
| 2 (e.g., cat food) | docID₂ₐ, . . . , docID₂ₓ |
| 3 (e.g., vertical label = sports) | docID₃ₐ, . . . , docID₃ₓ |
| . | |
| . | |
| . | |
| N (e.g., vertical label = news) | docID_{Na}, . . . , docID_{Nx} |

Exemplary indexing techniques for building a document index are disclosed in United States Patent publication 20060031195, which is hereby incorporated by reference herein in its entirety. By way of illustration, in some embodiments, a given search term may be associated with a particular document when the search term appears more than a threshold number of times in the document. Document index 150 stores the set of search terms, vertical labels, and other features, an associated document identifier uniquely identifying each document, and optionally scores of these documents. Those of skill in the art will appreciate that there are numerous methods for associating search terms with documents in order to build document index 150 and all such methods can be used to construct a document index 150 used in the systems and methods disclosed herein.

There is no limit to the number of search terms, vertical labels, and other features that may be present in document index 150. Moreover, there is no limit on the number of documents from document repository 152 that can be associated with each of these search terms, vertical labels, and other features in document index 150. For example, in some embodiments, between zero and 100 documents, between zero and 1000 documents, between zero and 10,000 documents, or more than 10,000 documents are associated with a given search term, vertical labels, or other feature. Moreover, there is no limit on the number of search terms, vertical labels, or other features to which a given document can be associated. For example, in some embodiments, a given document in document repository 152 is associated with between zero and 10, between zero and 100, between zero and 1000, between zero and 10,000, or more than 10,000 search terms, vertical labels, or other features. Typically, there are many documents represented by document index 150. For instance, in some embodiments there are more than one hundred thousand documents, more than one million documents, more than one billion documents represented by document index 150.

Advantageously, an augmented document index 150 that contains not only search terms but also vertical labels of particular vertical collections and quite possibly other features facilitates the vertically constrained search in step 214. For instance, all the documents that belong to a specific vertical collection (or, in another example, are not in a specific vertical collection) can rapidly be identified using the augmented document index 150. Then, further using the augmented document index, documents that have the appropriate vertical labels can be evaluated for relevance to the search query with the index of search terms in the document index 150 using any of a number of conventional methods.

In some alternative embodiments, vertical collections 144 are constructed using documents in document index 150 that pertain to a particular category. However, in the embodiment described above in which the document index 150 indexes search terms, vertical labels of vertical collections and possibly other features present in the documents of the document repository, the construction of vertical collections is not necessary. However, when vertical collections 144 are constructed, each document in a respective vertical collection 144 is assigned the vertical label for the respective vertical collection 144. For example, one vertical collection 144 may be constructed from documents indexed by document index 150 that pertain to movies using a classifier that is trained to recognize documents in document index 150 that pertain to movies. In this example, the vertical label for the vertical collection 144 might be “movies.” Another vertical collection 144 may be constructed from documents indexed by document index 150 that pertain to sports, and so forth. In some embodiments, there are hundreds, thousands, or tens of thousands of vertical collections 144, where each such vertical collection is associated with one or more vertical labels. In some embodiments, each vertical collection 144 has the form:

Vertical collection (V₁)
DocId₁₋₁
DocId₁₋₂
.
.
.
DocId_{1-P}

In some embodiments, each DocId in a vertical collection 144 further includes an assigned document quality score.

In step 216, in instances where the vertically constrained search was run, a combination of the first search result (from the one or more domain constrained searches) and the second search (from the one or more vertically constrained searches) is seamlessly outputted to a user interface device in user readable form, a monitor, a computer readable storage medium, a computer readable memory, or a local or remote computer system. The user is not aware that the search results of the two search types have been combined. Thus, in this manner, instances where the one or more domain constrained searches do not produce search results containing a sufficient number of documents and/or a sufficient number of relevant documents are compensated by making vertically constrained secondary searches as described herein and integrating, without human intervention, the domain constrained search results with the vertically constrained search results. The user benefits from this form of search by consistently getting relevant search results even when the domain constrained search fails to achieve a satisfactory search result. The site owner benefits from the method because it allows the site owner to place vertical constraints on the search and thus maintain some degree of control over the search. The first search is strictly domain controlled by the site owner (e.g., all the documents returned from the search are from, for example, documents stored by the host or at a URL path regulated by the host) whereas the second search, while less strictly controlled by the website owner, is regulated by the website owner in the sense that the website owner determines the vertical constraints of the second search.

In some embodiments, the combination of the domain constrained search results and the vertically constrained search results is the union of the domain constrained search results and the vertically constrained search results. In some embodiments, the combination of the domain constrained search results and the vertically constrained search result is the entirety of the domain constrained search results and a number of documents in the vertically constrained search results necessary to make the combination of the domain constrained search results and the vertically constrained search results exceed a predetermined number of documents. For example, this predetermined number of documents can be three or more documents, five or more documents, ten or more documents, etc.

In embodiments where a vertically constrained search is deemed to be unnecessary, (212—Yes), the outputting step 216 is reached without vertically constrained search results. In such instances, all or a portion of the domain constrained search results are outputted to a user in user readable form, a user interface, a monitor, a computer readable search medium, a computer readable memory, or a local or remote computer system. In the context of FIG. 1, a local computer system is host search engine 180 whereas a remote computer system is device 100 or some other computer that is in electrical communication with host search engine 180 or device 100.

In some embodiments, the search request provided by a user is redirected to host search engine 180 when the search request is received at website 36, where the domain constrained and vertically constrained searches are then performed. In some embodiments, as part of this redirection, a user ID of the site owner is sent to host search engine 180 along with the redirected search so that the search definition profile 34 of the site owner may be retrieved by host search engine 180 in order to direct the multi-step domain constrained, vertically construed searches. In some embodiments, the search results of step 216 are directed back to computer 100 as an XML feed or in some format so that the site owner can repackage the search results in any manner that is suitable to the user. In some embodiments, the search results of step 216 are sent by host search engine 180 directly back to a computer associated with the user that submitted the search query of step 206.

In some embodiments, search 210 is a vertically constrained search in addition to being a domain constrained search. In other words, in some embodiments, the scope of search 210 is determined by (e.g., limited by) at least one vertical constraint. Like the vertical constraints of step 214, the at least one vertical constraints in such embodiments can be an exclusive vertical constraint (e.g. acts to limit search 210 to documents that do not have a specific vertical label) or an inclusive vertical constraint (e.g. acts to limit search 210 to documents with a specific vertical label). In such embodiments, like the at least one vertical constraint of search 214, the at least one vertical constraint of search 210 in such embodiments requires that each respective document identified in the first search result satisfy the collective vertical constraint imposed by the at least one vertical constraint.

In another aspect, rather than having a domain constrained search followed by a vertically constrained search, a first vertically constrained search is run and then, if the search result from the first search is inadequate, a second vertically constrained search is run with a different collective vertical constraint. An embodiment in accordance with this aspect provides a first search for documents with a search query thereby obtaining a first search result. The first search is a vertically constrained search that is determined by one or more first vertical constraints. The one or more first vertical constraints require that each respective document identified in the first search result satisfy the collective vertical constraint collectively (logically) imposed by the one or more first vertical constraints. A relevance of the first search result is determined. When the relevance of the first search result does not achieve a predetermined relevance condition, the method further comprises executing a second search, without user intervention, for documents with the search query thereby obtaining a second search result. The second search is a vertically constrained search that is determined by one or more second vertical constraints. The one or more second vertical constraints require that each respective document identified in the second search satisfy the collective vertical constraint imposed by the one or more second vertical constraints. A combination of the first and second search results is then outputted to a user in user readable form, a user interface device, a monitor, a computer readable storage medium, a computer readable memory, or a local or remote computer system. On the other hand, when the relevance of the first search result does in fact achieve the predetermined relevance condition, the method further comprises outputting the first search result to in user readable form, a user interface device, a monitor, a computer readable storage medium, a computer readable memory, or a local or remote computer system.

Referring back to FIG. 2, embodiments in which a vertically constrained second search (step 214) is run when the relevance of a domain constrained first search (step 210) does not achieve a predetermined relevance condition have been described. In another aspect, the second search is always run regardless of the relevance of the first search. That is, the relevance of the domain constrained search results is not used to determine whether or not the vertically constrained search (step 214) will be run. Then, the search results of the domain constrained search alone is outputted when the search result of the domain constrained search consists of a sufficient number of documents (e.g., two or more documents, five or more documents, ten or more documents, etc.) and/or a number of documents have sufficient relevancy. Alternatively, when the domain constrained search result is not sufficient, a combination of the domain constrained search result and the vertically constrained search result is outputted. Such an embodiment has the advantage of performing the domain constrained and vertically constrained searches concurrently for faster processing. However, it is not necessary that the two search types by run concurrently. An embodiment in accordance with this aspect provides a computer-implemented method for obtaining a search result for a search query in which the domain constrained search for documents is executed with the search query thereby obtaining a first search result, where the first search is domain constrained. Without user intervention, a second search for documents is executed with the search query thereby obtaining a second search result. The second search is a vertically constrained search that is limited by a set of one or more vertical constraints. The first search result (the domain constrained search result) is outputted (when it is sufficiently relevant) or a combination of the domain constrained search result and the vertically constrained search result is outputted (when the domain constrained search result is not sufficiently relevant) to a user in user readable for, a user interface device, a monitor, a tangible computer readable storage medium, a computer readable memory, or a local or remote computer system. The nature of what constitutes a sufficiently relevant domain constrained search result in this context will be application dependent and there are a number of ways in which such relevance can be determined. For instance, each of the measures of sufficiency described above in conjunction with step 212 can be used.

In either the embodiment described in conjunction with FIG. 2 or the embodiment described above in which the vertically constrained search is automatically run without first considering the relevance of the search result of the domain constrained search, it is quite possible that the first search is run by one host (computer) or process and the second search is run by another host (computer) or process or both processes are run in a cluster.

An embodiment provides a computer-implemented method for performing a search query created by a user. The method comprises obtaining a search definition profile, where the search definition profile comprises a first search definition comprising a set of one or more domain constraints, and a second search definition comprising a first set of one or more vertical constraints. The set of one or more domain constraints and the first set of one or more vertical constraints are specified by someone other than the user (e.g. the owner or controller of website 36 of FIG. 1). A search query is received from a user. A first search for documents with the search query is executed, thereby obtaining a first search result, where the first search is constrained to searching documents that satisfy the collective domain constraint imposed by the one or more domain constraints specified by the first search definition. A relevance of the first search result is determined. When the relevance of the first search result does not achieve a first predetermined relevance condition, the method further comprises (i) executing, without user intervention, a second search for documents with the search query thereby obtaining a second search result, where the second search is constrained to documents that satisfy the collective vertical constraint imposed by the first set of one or more vertical constraints, and (ii) forming an output search result that is combination of one or more documents in or referenced by the first search result and one or more documents in or referenced by the second search result. In the alternative, when the relevance of the first search result achieves the predetermined relevance condition, the method further comprises forming an output search result for the search that is one or more documents in or referenced by the first search result. A relevance of the second search result is determined when the relevance of the first search result does not achieve the first predetermined relevance condition, where (i) when the relevance of the second search result does not achieve the second predetermined relevance condition, the method further comprises (a) executing, without user intervention, a third search for documents with the search query thereby obtaining a third search result, where the third search is an unconstrained search for documents indexed by an index of documents obtained from an unconstrained crawl of the Internet, and (b) forming an output search result that is a combination of one or more documents in or referenced by the first search result, one or more documents in or referenced by the second search result, and one or more documents in or referenced by the third search result. In the alternative, when a relevance of the second search result achieves the second predetermined relevance value, the method further comprises forming an output search result for the search that is a combination of one or more documents in or referenced by the first search result and one or more documents in or referenced by the second search result. The output search result is then outputted to a user in a user readable form, a user interface device, a monitor, a tangible computer readable storage medium, a computer readable memory, a local computer system, or a remote computer system.

Another aspect provides a computer-implemented method for performing a search query created by a user in which a search definition profile is obtained. The search definition profile comprises a first search definition comprising a set of one or more domain constraints and a second search definition comprising a first set of one or more vertical constraints. The set of one or more domain constraints and the first set of one or more vertical constraints are specified by the site owner and cannot be modified by a search user. The search query is received by a search engine from the site owner when a search user submits a search request to the site owner, whereupon a first search for documents is executed with the search query thereby obtaining a first search result. The first search is constrained to searching documents that satisfy the collective domain constrain imposed by the one or more domain constraints in the first search definition. A second search for documents is executed, without user intervention, with the search query thereby obtaining a second search result. The second search is constrained to documents that satisfy the collective vertical constraint of the first set of one or more vertical constraints. An output search result that is combination of one or more documents in or referenced by the first search result and one or more documents in or referenced by the second search result is outputted to a user in user readable form, an interface device, a monitor, a tangible computer readable storage medium, a computer readable memory, a local computer system, or a remote computer system. In some embodiments, a vertical constraint in the first set of one or more vertical constraints is a requirement that a characterization of a document in the first search result matches a vertical characterization specified by the vertical constraint. In some embodiments, the characterization of the document is determined by an automated classifier that has been trained with a training set of documents. In some embodiments, a vertical constraint in the first set of one or more vertical constraints is a requirement that a characterization of a document in the first search result does not match a vertical characterization specified by the vertical constraint.

In some embodiments, the characterization of the document is determined by an automated classifier that has been trained with a training set of documents. In some embodiments, a vertical constraint in the first set of one or more vertical constraints requires that a document in the second search result provide a predetermined service, a predetermined class of services, a product, or a predetermined class of products. In some embodiments, a vertical constraint in the first set of one or more vertical constraints requires that a document in the second search result not provide a predetermined service, a predetermined class of services, a predetermined product, or a predetermined class of products. In some embodiments, a first domain requirement in the set of one or more domain requirements requires that a document be in a predetermined second-level domain or a predetermined plurality of second-level domains. In some embodiments, a first domain requirement in the set of one or more domain requirements requires that the document be from a URL that contains a predetermined search string or be from a uniform resource location in a predetermined plurality of second-level domains. In some embodiments, the set of one or more domain constraints requires a document to be from a predetermined host or from a predetermined URL path. In some embodiments, the search query is a product search query for a product that is manufactured or sold by a site owner. In some embodiments, the first search definition further comprises a second set of one or more vertical constraints, where the first search is further constrained to documents that satisfy the collective vertical constraint of the second set of one or more vertical constraints. In some embodiments, the obtaining step described above comprises receiving, at the search engine 180, an identifier that identifies a database entry or a data structure that contains or references the search definition profile associated with the site owner that has passed on the search request from the user. In some embodiments the search definition profile is embedded in the search query.

The present invention can be implemented as a computer program product that comprises a computer program mechanism embedded in a computer readable storage medium. Further, any of the methods of the present invention can be implemented in one or more computers or computer systems or other forms of apparatus. Further still, any of the methods of the present invention can be implemented in one or more computer program products. Some embodiments of the present invention provide a computer system or a computer program product that encodes or has instructions for performing any or all of the methods disclosed herein. Such methods/instructions can be stored on a CD-ROM, DVD, magnetic disk storage product, or any other tangible computer readable data or tangible program storage product. Such methods can also be embedded in tangible permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or any other tangible electronic devices.

All references cited herein are incorporated herein by reference in their entirety and for all purposes to the same extent as if each individual publication or patent or patent application was specifically and individually indicated to be incorporated by reference in its entirety for all purposes.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed:

1. A computer-implemented method for performing a search query created by a user, the method comprising:
(A) obtaining a search definition profile, wherein the search definition profile comprises:
a first search definition comprising a set of one or more domain constraints, and
a second search definition comprising a first set of one or more vertical constraints,
wherein the set of one or more domain constraints and the first set of one or more vertical constraints are specified by a site owner;
(B) receiving said search query;
(C) executing a first search for documents with said search query thereby obtaining a first search result, wherein the first search result is constrained to documents in a search engine index that satisfy a collective domain constraint imposed by the set of one or more domain constraints; and
(D) determining a relevance of the first search result; wherein
(i) when the relevance of the first search result does not satisfy a predetermined relevance condition, the method further comprises:
executing, without user intervention, a second search for documents with the search query thereby obtaining a second search result, wherein the second search is constrained to documents in the search engine index that satisfy a collective vertical constraint imposed by the first set of one or more vertical constraints; and
forming an output search result that is combination of one or more documents in or referenced by the first search result and one or more documents in or referenced by the second search result; and
(ii) when the relevance of the first search result satisfies the predetermined relevance condition, the method further comprises:
forming an output search result for the search that is one or more documents in or referenced by the first search result; and
(E) outputting the output search result to a user in user readable form, a user interface device, a monitor, a tangible computer readable storage medium, a computer readable memory, a local computer system, or a remote computer system.

2. The computer-implemented method of claim 1, wherein the search definition profile is embedded in the search query by the site owner after the user submits the search query to the site owner.

3. The computer-implemented method of claim 2, wherein the search definition profile is embedded in the search query in the form of one or more instructions not accessible to the user.

4. The computer-implemented method of claim 1, wherein
the search definition profile is in a data store that comprises a plurality of search definition profiles; and
the site owner adds a reference to the search definition profile in the data store to be used in the executing (C) and determining (D) to the search query after the user submits the search query to the site owner and wherein the obtaining (A) comprises using the reference to the search definition profile in the search query to identify and obtain the search definition profile from the data store.

5. The computer-implemented method of claim 1, wherein
the search definition profile is in a data store that comprises a plurality of search definition profiles; and
the obtaining (A) comprises using a source address of the site owner to identify and obtain the search definition profile, to be used in the executing (C) and determining (D), from the data store.

6. The computer-implemented method of claim 1, wherein a vertical constraint in the first set of one or more vertical constraints is a requirement that a characterization of a document in the first search result matches a vertical characterization specified by the vertical constraint.

7. The computer-implemented method of claim 6, wherein the characterization of the document is determined by an automated classifier that has been trained with a training set of documents to characterize the document.

8. The computer-implemented method of claim 1, wherein a vertical constraint in the first set of one or more vertical constraints is a requirement that a characterization of a document in the first search result does not match a vertical characterization specified by the vertical constraint.

9. The computer-implemented method of claim 8, wherein the characterization of the document is determined by an automated classifier that has been trained with a training set of documents to characterize the document.

10. The computer-implemented method of claim 1, wherein the relevance of the first search result does not satisfy the predetermined condition, and wherein the collective vertical constraint imposed by the first set of one or more vertical constraints requires that each document identified in the second search result be characterized by a predetermined vertical label.

11. The computer-implemented method of claim 1, wherein the collective vertical constraint imposed by the first set of one or more vertical constraints requires that a document in the second search result provide a predetermined service, a predetermined class of services, a product, or a predetermined class of products.

12. The computer-implemented method of claim 1, wherein the collective vertical constraint imposed by the first set of one or more vertical constraints requires that a document in the second search result not provide a predetermined service, a predetermined class of services, a predetermined product, or a predetermined class of products.

13. The computer-implemented method of claim 1, wherein the relevance of the first search result does not satisfy the predetermined condition, and wherein the collective vertical constraint imposed by the first set of one or more vertical constraints requires that documents identified in the second search be those documents in the search engine document index that have been assigned both a first vertical label and a second vertical label.

14. The computer-implemented method of claim 1, wherein the relevance of the first search result does not satisfy the predetermined condition, and wherein the collective vertical constraint imposed by the first set of one or more vertical constraints requires that each document in the second search result be in a first vertical collection but not a second vertical collection.

15. The computer-implemented method of claim 1, wherein the relevance of the first search result does not satisfy the predetermined condition, and wherein the documents identified in the second search result are restricted to those documents that have a predetermined relevance to a predetermined category.

16. The computer-implemented method of claim 1, wherein the collective domain constraint imposes the requirement that each document in the first search result be a document in the search engine index that was indexed from a predetermined second-level domain or a predetermined plurality of second-level domains.

17. The computer-implemented method of claim 1, wherein the collective domain constraint imposes the requirement that each document in the first search result contain a predetermined search string and be indexed from a uniform resource location in a predetermined plurality of second-level domains.

18. The computer-implemented method of claim 1, wherein the condition of the first search result does not satisfy the predetermined relevance condition, and wherein the output search result is the union of the first search result and the second search result.

19. The computer-implemented method of claim 1, wherein the relevance of the first search result does not satisfy the predetermined relevance condition, and wherein the output search is the entirety of the first search result and a number of documents in the second search result necessary to make a number of documents in the output search result equal or exceed a predetermined number of documents.

20. The computer-implemented method of claim 1, wherein the collective domain constraint imposes a requirement that each document in the first search result be indexed from a predetermined host or a predetermined URL path.

21. The computer-implemented method of claim 1, wherein the search query is a product search query for a product that is manufactured or sold by a predetermined host or a registrant of a predetermined URL path.

22. The computer-implemented method of claim 1, wherein the predetermined relevance condition is a predetermined number of documents in the first search result, wherein
the relevance of the first search result does not satisfy the predetermined relevance condition when the first search contains less than the predetermined number of documents; and
the relevance of the first search result satisfies the predetermined relevance condition when the first search contains more than the predetermined number of documents.

23. The computer-implemented method of claim 1, wherein the predetermined relevance condition is a predetermined number of documents in the first search result, wherein
the relevance of the first search result satisfies the predetermined relevance condition when the first search contains less than the predetermined number of documents; and
the relevance of the first search result does not satisfy the predetermined relevance condition when the first search contains more than the predetermined number of documents.

24. The computer-implemented method of claim 1, wherein the predetermined relevance condition is a predetermined number of documents in the first search result that each have a relevance that satisfies a predetermined relevance, wherein
the relevance of the first search result does not satisfy the predetermined relevance condition when the number of documents in the first search result that each have a relevance to the search query that satisfies the predetermined relevance is less than the predetermined number of documents; and
the relevance of the first search result satisfies the predetermined relevance condition when the number of documents in the first search result that each have a relevance to the search query that achieves the predetermined relevance is greater than the predetermined number of documents.

25. The computer-implemented method of claim 1, wherein the predetermined relevance condition is a predetermined number of documents in the first search result that each have a relevance that satisfies a predetermined relevance, wherein
the relevance of the first search result satisfies the predetermined relevance condition when the number of documents in the first search result that each have a relevance to the search query that satisfies a predetermined relevance is less than the predetermined number of documents; and
the relevance of the first search result does not satisfy the predetermined relevance condition when the number of documents in the first search result that each have a relevance to the search query that satisfies a predetermined relevance is greater than the predetermined number of documents.

26. The computer-implemented method of claim 1, wherein the predetermined relevance condition is a summation of the relevance of each of the documents in the first search result to the search query, wherein
the relevance of the first search result does not satisfy the predetermined relevance condition when the summation of the relevance of each of the documents in the first search result is less than the predetermined number of documents; and
the relevance of the first search result satisfies the predetermined relevance condition when the summation of the relevance of each of the documents in the first search result is greater than the predetermined number of documents.

27. The computer-implemented method of claim 1, wherein the predetermined relevance condition is a summation of the relevance of each of the documents in the first search result to the first search result, wherein
the relevance of the first search result satisfies the predetermined relevance condition when the summation of the relevance of each of the documents in the first search result is less than the predetermined number of documents; and
the relevance of the first search result does not satisfy the predetermined relevance condition when the summation of the relevance of each of the documents in the first search result is greater than the predetermined number of documents.

28. The computer-implemented method of claim 1, wherein the first search definition further comprises a second set of one or more vertical constraints, wherein the first search is further constrained to documents that satisfy a collective vertical constraint imposed by the second set of one or more vertical constraints.

29. The computer-implemented method of claim 1, wherein the obtaining (A) comprises receiving an identifier that identifies a database entry or a data structure that contains or references the search definition profile.

30. The computer-implemented method of claim 1, wherein the relevance of the first search result satisfies the predetermined reference value.

31. The computer-implemented method of claim 1, the method further comprising, prior to the obtaining (A) and the receiving (B):
forming the search engine index from documents in a document repository of documents found on the Internet; and
categorizing each respective document in the document repository into one or more vertical collections in a plurality of vertical collections, wherein the one or more vertical constraints specifies a subset of the vertical collections.

32. A computer comprising:
a central processing unit; and
a memory coupled to the central processing unit, the memory comprising a search module for performing a search query created by a user, the search module comprising:
(A) instructions for obtaining a search definition profile, wherein the search definition profile comprises:
a first search definition comprising a set of one or more domain constraints, and
a second search definition comprising a first set of one or more vertical constraints,
wherein the set of one or more domain constraints and the first set of one or more vertical constraints are specified by a site owner;
(B) instructions for receiving said search query;
(C) instructions for executing a first search for documents with said search query thereby obtaining a first search result, wherein the first search result is constrained to documents in a search engine index that satisfy a collective domain constraint imposed by the set of one or more domain constraints in the first search definition; and
(D) instructions for determining a relevance of the first search result; wherein
(i) when the relevance of the first search result does not satisfy a predetermined relevance condition, the method further comprises:
executing, without user intervention, a second search for documents with the search query thereby obtaining a second search result, wherein the second search is constrained to documents in the search engine index that satisfy a collective vertical constraint imposed by the first set of one or more vertical constraints; and
forming an output search result that is combination of one or more documents in or referenced by the first search result and one or more documents in or referenced by the second search result; and
(ii) when the relevance of the first search result satisfies the predetermined relevance condition, the method further comprises:
forming an output search result for the search that is one or more documents in or referenced by the first search result; and
(E) instructions for outputting the output search result to a user in user readable form, a user interface device, a monitor, a tangible computer readable storage medium, a computer readable memory, a local computer system, or a remote computer system.

33. A computer-implemented method to obtain a search result for a search query created by a user, the method comprising:
(A) obtaining a search definition profile, wherein the search definition profile comprises:
a first search definition comprising a first set of one or more vertical constraints, and
a second search definition comprising a second set of one or more vertical constraints,
wherein the first set of one or more vertical constraints and the second set of one or more vertical constraints are specified by a site owner;
(B) receiving said search query;
(C) executing a first search for documents with said search query thereby obtaining a first search result, wherein the first search result is constrained to documents in a search engine index that satisfy a first collective vertical constraint imposed by the first set of one or more vertical constraints; and
(D) determining a relevance of the first search result; wherein
(i) when the relevance of the first search result does not satisfy a predetermined relevance condition, the method further comprises:
executing, without user intervention, a second search for documents with the search query thereby obtaining a second search result, wherein the second search is constrained to documents in the search engine index that satisfy a second collective vertical constraint imposed by the second set of one or more vertical constraints; and
forming an output search result that is combination of one or more documents in or referenced by the first search result and one or more documents in or referenced by the second search result; and
(ii) when the relevance of the first search result satisfies the predetermined relevance condition, the method further comprises:
forming an output search result for the search that is one or more documents in or referenced by the first search result; and
(E) outputting the output search result to a user in user readable form, a user interface device, a monitor, a tangible computer readable storage medium, a computer readable memory, a local computer system, or a remote computer system.

34. The computer-implemented method of claim 33, wherein at least one vertical constraint in the first set of one or more vertical constraints is not in the second set of one or more vertical constraints.

35. The computer-implemented method of claim 33, wherein at least one vertical constraint in the second set of one or more vertical constraints is not in the first set of one or more vertical constraints.

36. A computer comprising:
a central processing unit; and
a memory, coupled to the central processing unit, the memory comprising a search module for obtaining an output search result for a search query created by a user, the search module comprising:
(A) instructions for obtaining a search definition profile, wherein the search definition profile comprises:
a first search definition comprising a first set of one or more vertical constraints, and
a second search definition comprising a second set of one or more vertical constraints,
wherein the first set of one or more vertical constraints and the second set of one or more vertical constraints are specified by a site owner;
(B) instructions for receiving said search query;
(C) instructions for executing a first search for documents with said search query thereby obtaining a first search result, wherein the first search is constrained to documents in a search engine index that satisfy a first collective vertical constraint imposed by the first set of one or more vertical constraints; and
(D) instructions for determining a relevance of the first search result; wherein
(i) when the relevance of the first search result does not satisfy a predetermined relevance condition, the method further comprises:
executing, without user intervention, a second search for documents with the search query thereby obtaining a second search result, wherein the second search is constrained to documents in the search engine index that satisfy a second collective vertical constraint imposed by the second set of one or more vertical constraints; and
forming an output search result that is combination of one or more documents in or referenced by the first search result and one or more documents in or referenced by the second search result; and
(ii) when the relevance of the first search result satisfies the predetermined relevance condition, the method further comprises:
forming an output search result for the search that is one or more documents in or referenced by the first search result; and
(E) instructions for outputting the output search result to a user in user readable form, a user interface device, a monitor, a tangible computer readable storage medium, a computer readable memory, a local computer system, or a remote computer system.

37. The computer of claim 36, wherein at least one vertical constraint in the first set of one or more vertical constraints is not in the second set of one or more vertical constraints.

38. The computer of claim 36, wherein at least one vertical constraint in the second set of one or more vertical constraints is not in the first set of one or more vertical constraints.

39. A computer-implemented method for performing a search query created by a user, the method comprising:
(A) obtaining a search definition profile, wherein the search definition profile comprises:
a first search definition comprising a set of one or more domain constraints, and
a second search definition comprising a first set of one or more vertical constraints,
wherein the set of one or more domain constraints and the first set of one or more vertical constraints are specified by a site owner;
(B) receiving said search query;
(C) executing a first search for documents with said search query thereby obtaining a first search result, wherein the first search is constrained to searching documents in a search engine index that satisfy a collective domain constraint imposed by the set of one or more domain constraints specified by the first search definition; and
(D) determining a relevance of the first search result; wherein
(i) when the relevance of the first search result does not satisfy a first predetermined relevance condition, the method further comprises:
executing, without user intervention, a second search for documents with the search query thereby obtaining a second search result, wherein the second search is constrained to documents in a search engine index that satisfy a collective vertical constraint imposed by the first set of one or more vertical constraints; and
forming an output search result that is combination of one or more documents in or referenced by the first search result and one or more documents in or referenced by the second search result; and
(ii) when the relevance of the first search result satisfies the first predetermined relevance condition, the method further comprises:
forming an output search result for the search that is one or more documents in or referenced by the first search result;
(E) determining a relevance of the second search result when the relevance of the first search result does not satisfy a second predetermined relevance value; wherein
(i) when the relevance of the second search result does not satisfy the second predetermined relevance value, the method further comprises:
executing, without user intervention, a third search for documents with the search query thereby obtaining a third search result, wherein the third search is an unconstrained search for documents in the search engine index that were obtained from an unconstrained crawl of the Internet; and
forming an output search result that is a combination of one or more documents in or referenced by the first search result, one or more documents in or referenced by the second search result, and one or more documents in or referenced by the third search result; and
(ii) when a relevance of the second search result satisfies the second predetermined relevance value, the method further comprises:
forming an output search result for the search that is a combination of one or more documents in or referenced by the first search result and one or more documents in or referenced by the second search result; and
(F) outputting the output search result to a user in user readable form, a user interface device, a monitor, a tangible computer readable storage medium, a computer readable memory, a local computer system, or a remote computer system.

40. A computer-implemented method for performing a search query created by a user, the method comprising:
(A) obtaining a search definition profile, wherein the search definition profile comprises:
a first search definition comprising a set of one or more domain constraints, and
a second search definition comprising a first set of one or more vertical constraints,
wherein the set of one or more domain constraints and the first set of one or more vertical constraints are specified by a site owner;
(B) receiving said search query;
(C) executing a first search for documents with said search query thereby obtaining a first search result, wherein the first search result is constrained to documents in a search engine index that satisfy a collective domain constraint imposed by the set of one or more domain constraints;
(D) executing, without user intervention, a second search for documents with the search query thereby obtaining a second search result, wherein the second search is constrained to documents in the search engine index that satisfy a collective vertical constraint imposed by in first set of one or more vertical constraints;
(E) forming an output search result that is combination of one or more documents in or referenced by the first search result and one or more documents in or referenced by the second search result; and
(F) outputting the output search result to a user in user readable form, a user interface device, a monitor, a tangible computer readable storage medium, a computer readable memory, a local computer system, or a remote computer system.

41. The computer-implemented method of claim 40, wherein the collective vertical constraint imposed by the first set of one or more vertical constraints is a requirement that a characterization of a document in the first search result does not match a predetermined vertical characterization.

42. The computer-implemented method of claim 41, wherein the characterization of the document is determined by an automated classifier that has been trained with a training set of documents to characterize the document.

43. The computer-implemented method of claim 40, wherein the collective vertical constraint requires that a document in the second search result provide a predetermined service, a predetermined class of services, a product, or a predetermined class of products.

44. The computer-implemented method of claim 40, wherein the collective vertical constraint requires that a document in the second search result not provide a predetermined service, a predetermined class of services, a predetermined product, or a predetermined class of products.

45. The computer-implemented method of claim 40, wherein the collective domain constraint requires that each document in the first search result be indexed from a predetermined second-level domain or be indexed from a predetermined plurality of second-level domains.

46. The computer-implemented method of claim 40, wherein the collective domain constraint requires that each document in the first search result be index contain a predetermined search string and be index from a uniform resource location in a predetermined plurality of second-level domains.

47. The computer-implemented method of claim 40, wherein the collective domain constraint requires that each document in the first search result be indexed from a predetermined host or indexed from a predetermined URL path.

48. The computer-implemented method of claim 40, wherein the search query is a product search query for a product that is manufactured or sold by a predetermined host or a registrant of a predetermined URL path.

49. The computer-implemented method of claim 40, wherein the first search definition further comprises a second set of one or more vertical constraints, wherein the first search is further constrained to a second collective vertical constraint imposed by the second set of one or more vertical constraints.

50. The computer-implemented method of claim 40, wherein the obtaining (A) comprises receiving an identifier that identifies a database entry or a data structure that contains or references the search definition profile.

51. The computer-implemented method of claim 40, the method further comprising, prior to the obtaining (A) and the receiving (B):
forming said search engine index using a document repository of documents found on the Internet; and
categorizing each respective document in the document repository into one or more vertical collections in a plurality of vertical collections, wherein the one or more vertical constraints specifies a subset of the vertical collections.

52. The computer-implemented method of claim 40, wherein the search definition profile is embedded in the search query by the site owner after the user has submitted the search query to the site owner.

53. The computer-implemented method of claim 52, wherein the search definition profile is embedded in the search query in the form of one or more instructions not accessible to the user.

54. The computer-implemented method of claim 40, wherein
the search definition profile is in a data store that comprises a plurality of search definition profiles; and
the search query comprises a reference to the search definition profile in the data store, added to the search query by the site owner, wherein the reference to the search definition profile is used in the executing (C) and executing (D) and wherein the obtaining (A) comprises using the reference to the search definition profile in the search query to identify and obtain the search definition profile from the data store.

55. The computer-implemented method of claim 40, wherein
the search definition profile is in a data store that comprises a plurality of search definition profiles; and
the obtaining (A) comprises using a source address of the search to identify and obtain the search definition profile to be used in the executing (C) and executing (D) from the data store.

56. A computer comprising:
a central processing unit; and
a memory coupled to the central processing unit, the memory comprising instructions for carrying out the method of claim 40.

57. A computer program product for use in conjunction with a computer system, the computer program product comprising a computer readable storage medium and a computer program mechanism embedded therein, the computer program mechanism for obtaining a search result, the computer program mechanism comprising instructions for carrying out the computer-implemented method of claim 1.

58. A computer program product for use in conjunction with a computer system, the computer program product comprising a computer readable storage medium and a computer program mechanism embedded therein, the computer program mechanism for obtaining a search result, the computer program mechanism comprising instructions for carrying out the computer-implemented method of claim 33.

59. A computer program product for use in conjunction with a computer system, the computer program product comprising a computer readable storage medium and a computer program mechanism embedded therein, the computer program mechanism for obtaining a search result, the computer program mechanism comprising instructions for carrying out the computer-implemented method of claim 39.

60. A computer program product for use in conjunction with a computer system, the computer program product comprising a computer readable storage medium and a computer program mechanism embedded therein, the computer program mechanism for obtaining a search result, the computer program mechanism comprising instructions for carrying out the computer-implemented method of claim 40.

61. The computer-implemented method of claim 1, wherein the predetermined relevance condition is stored in the search definition profile and is specified by the site owner.
